(19) United States
(12) Patent Application Publication
(10) Pub. No.: US 2003/0194513 A1
(43) Pub. Date: Oct. 16, 2003

(54) Ink jet recording medium

(76) Inventor: Steven A. Carlson, Cambridge, MA (US)

Correspondence Address: Richard L. Sampson, Sampson & Associates, P.C., 50 Congress Street, Boston, MA, 02109, US

(21) Appl. No.: 10/404,029

(22) Filed: Apr. 1, 2003

Related U.S. Application Data
(60) Provisional application No. 60/369,954, filed on Apr. 4, 2002.

(51) Int. Cl. B32B 3/00

(52) U.S. Cl. 428/32.1

(57) ABSTRACT

Provided are ink jet recording media comprising a substrate and a porous layer, wherein the porous layer comprises an inorganic oxide, preferably an inorganic oxide xerogel, an organic polymer as a binder, an aminium radical cation, and an arylamine. The aminium radical cation and the arylamine are added to reduce the fading of the colorants in the ink jet media after imaging. Also provided are imaged ink jet media comprising such stabilizing additives and layers and methods of preparing such ink jet recording media and such imaged ink jet media.

### RELATED APPLICATION

This application claims priority to U.S. Provisional Patent Application No. 60/369,954, filed Apr. 4, 2002, the disclosure of which is fully incorporated herein for all purposes.

### FIELD OF THE INVENTION

The present invention relates generally to the field of imaging or recording using ink jet printers, and particularly, pertains to ink jet imaging media and to the imaged media produced after printing on media with an ink jet printer. More specifically, this invention pertains to ink jet imaging media and to the imaged ink jet media comprising additives to improve the archival properties of the ink jet media after imaging. This invention also pertains to methods of preparing such ink jet imaging media and such imaged ink jet media.

### BACKGROUND OF THE INVENTION

Throughout this application, various patents are referred to by an identifying citation. The disclosures of the patents referenced in this application are hereby incorporated by reference into the present disclosure to more fully describe the state of the art to which this invention pertains.

As color digital imaging with various types of printers has gained increasing commercial acceptance, ink jet printing has surpassed sublimation type thermal transfer printing as the most accepted method for color digital printing. Where photographic quality, as exemplified by silver halide color photography, or close to photographic quality, is desired in the color digital printing, the ink jet imaging media typically utilize an inorganic porous layer or a swellable organic polymer layer as the recording or imaging layer. Such an imaging media having an inorganic porous layer are excellent in ink jet ink absorptivity and drying speed and also in the property of fixing or complexing the colorants to provide high resolution images. An example of such an ink jet imaging media is described in U.S. Pat. No. 5,104,730 to Misuda et al., where the inorganic porous layer is made mainly of psuedo boehmite, a type of alumina hydrate. However, ink jet imaging media with an inorganic porous layer as a recording layer have disadvantages in that during the storage after printing, and especially when exposed to light from various sources, the images on the media tend to fade and also the background or non-imaged areas may tend to develop some coloration, especially along the edges of the media.

In an attempt to overcome these disadvantages, various materials have been suggested for addition to the inorganic porous layer. Materials that are added to reduce the fading of the ink jet image are described, for example, in U.S. Pat. No. 5,670,249 to Tanuma, where the stabilizing materials are selected from the group consisting of dithiocarbamates, thiurams, thiocyanate esters, thiocyanates, and hindered amines; and in U.S. Pat. No. 6,344,262 to Suzuki, where the stabilizing materials for an inorganic porous layer containing an alumina hydrate are magnesium ions and thiocyanate ions. Materials that are added to reduce the background discoloration of the ink jet media are described, for example, in U.S. Pat. No. 5,445,868 to Harasawa et al., where the stabilizing material for a colorant absorbing layer having porous inorganic oxide particles bonded by a binder is an organic acid with the first acid dissociation exponent of at most 5, which has an aromatic nucleus or at least two carboxyl groups.

It would be advantageous if improved stabilizers for ink jet imaging media containing porous inorganic oxide layers were available to reduce the fading of the color images and to reduce the discoloration of the non-imaged areas, without also impacting the excellent drying rates and ink jet image resolution and quality due to the properties of the porous inorganic oxide layers.

### SUMMARY OF THE INVENTION

One aspect of this invention pertains to an ink jet recording medium comprising a substrate and a porous layer, wherein the porous layer comprises an inorganic oxide, preferably an inorganic oxide xerogel, an organic polymer as a binder, an aminium radical cation, and an arylamine. In one embodiment, the arylamine is the one-electron reduction product of the aminium radical cation. In one embodiment, the arylamine is the two-electron reduction product of the aminium radical cation. In one embodiment, the aminium radical cation is a tetrakis (N,N-disubstituted aminophenyl)-1,4-benzenediamine radical cation. In one embodiment, the aminium radical cation is a tris (N,N-disubstituted aminophenyl) aminium radical cation.

In one embodiment of the ink jet recording media of this invention, the inorganic oxide is a xerogel selected from the group consisting of silica xerogels, alumina xerogels, zirconium oxide xerogels, and combinations thereof. In a preferred embodiment, the inorganic xerogel comprises a pseudo boehmite xerogel. In one embodiment, the organic polymer for the binder is selected from the group consisting of polyvinyl alcohol, modified polyvinyl alcohols, polyethylene oxide, modified polyethylene oxides, cellulosics, polyvinyl pyrrolidone, and modified polyvinyl pyrrolidones.

In one embodiment of the ink jet recording media of the present invention, the porous layer comprises an anionic organic compound, preferably an anionic organic compound comprising an anionic moiety selected from the group consisting of sulfonate, carboxylate, and phosphate moieties. In a preferred embodiment, the anionic organic compound is complexed to the inorganic oxide. In a more preferred embodiment, the anionic compound complexed to the inorganic oxide comprises two or more anionic moieties on the anionic organic compound. Most preferably, the anionic organic compound comprising two or more anionic moieties is complexed to the inorganic oxide and to the aminium radical cation. In one embodiment, the aminium radical cation comprises one or more anionic moieties. In one embodiment, the arylamine comprises one or more anionic moieties.

In one embodiment of the ink jet recording media of this invention, the ink jet recording medium further comprises a surface layer, wherein the surface layer comprises polymer particles which have not coalesced to form a uniform, continuous film. In one embodiment, the surface layer further comprises an inorganic oxide, preferably an inorganic oxide xerogel. In one embodiment, the surface layer further comprises an organic polymer selected from the group consisting of polyvinyl alcohol, modified polyvinyl alcohols, polyethylene oxide, modified polyethylene oxides, cellulosics, polyvinyl pyrrolidone, and modified polyvinyl pyrrolidones.

Another aspect of this invention pertains to an imaged ink jet recording medium comprising the ink jet recording medium of the present invention and a colorant applied in an imagewise pattern by an ink jet printer.

Still another aspect of the present invention pertains to an imaged ink jet recording media comprising the ink jet recording media having a surface layer comprising polymer particles which have not coalesced to form a uniform, continuous film prior to the application of the colorant by the ink jet printer of this invention, wherein the surface layer comprises polymer particles that are coalesced, such as, for example, by the application of heat and/or pressure, subsequent to the application of the colorant by the ink jet printer.

As will be appreciated by one of skill in the art, features of one aspect or embodiment of the invention are also applicable to other aspects or embodiments of the invention.

### DETAILED DESCRIPTION OF THE INVENTION

The ink jet recording media and imaged ink jet recording media of this invention comprise additives that provide increased stability to colored ink jet images. These stabilizing additives are particularly useful with, but are not limited to, ink jet recording media having porous inorganic oxide layers that show excellent ink drying rates and image resolution and quality, but have disadvantages for stability against fading of the color ink jet images and against discoloration of the non-imaged, background areas.

One aspect of this invention pertains to an ink jet recording medium comprising a substrate and a porous layer, wherein the porous layer comprises an inorganic oxide, an organic polymer, an aminium radical cation, and an arylamine. Preferably, the inorganic oxide is a xerogel. The organic polymer functions as a binder for the porous layer. The aminium radical cation and the arylamine function as anti-fading agents which reduce the fading of the color ink images during storage after ink jet printing, especially when the images are exposed to light for extended periods of time. These aminium radical cations and these arylamines may be used alone to provide anti-fading effects. However, preferably, they are used in combination in a mixture of the aminium radical cation and of the arylamine to obtain increased anti-fading effects.

The ink jet recording media of the present invention are excellent in the absorption and fast drying of the ink jet ink and in fixing or complexing the colorant to provide sharp and intense color images.

Suitable aminium radical cations include, but are not limited to, tris (N,N-disubstituted aminophenyl) aminium radical cations and tetrakis (N,N-disubstituted aminophenyl)-1,4-benzenediamine radical cations. An example of a tris (N,N-disubstituted aminophenyl) aminium radical cation is tris (4-dibutylaminophenyl) aminium hexafluoroantimonate (I), which is commercially available as IR-99, a tradename for a dye available from GPT Glendale, Attleboro Falls, Mass. An equivalent chemical name for IR-99, used interchangeably herein, is the hexafluoroantimonate salt of N,N-dibutyl-N′,N′-bis[4-(dibutylamino)phenyl]-1,4-benzenediamine radical cation. An example of a tetrakis (N,N-disubstituted aminophenyl)-1,4-benzenediamine radical cation is the hexafluoroantimonate salt of tetrakis [4-(dibutylamino)phenyl]-1,4-benzenediamine radical cation (II), which is commercially available as IR-126, a tradename for a dye available from GPT Glendale, Attleboro falls, Mass.

The chemical structure of tris (4-dibutylaminophenyl) aminium hexafluoroantimonate, 1, is shown below:

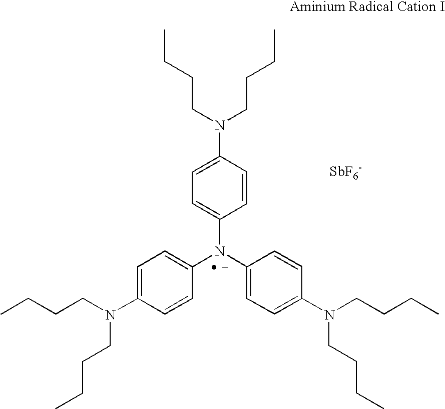

Suitable arylamines include, but are not limited to, tris (N,N-disubstituted aminophenyl) amines and tetrakis (N,N-disubstituted aminophenyl)-1,4-benzenediamines. An example of a tris (N,N-disubstituted aminophenyl) amine is tris (4-dibutylaminophenyl) amine (III), which has an equivalent chemical name, used interchangeably herein, of N,N-dibutyl-N′,N′-bis[4-(dibutylamino)phenyl]-1,4-benzenediamine. An example of a tetrakis (N,N-disubstituted aminophenyl)-1,4-benzenediamine is tetrakis [4-(dibutylamino)phenyl]-1,4-benzenediamine (IV).

The aminium radical cations may be a salt of an aminium radical cation, such as the hexafluoroantimonate salts of aminium radical cations I and II. Other suitable anions for the salt forms of aminium radical cations include, but are not limited to, borofluoride (BF₄-) and hexafluorophosphate (PF-) anions. When the aminium radical cation is formed photolytically or by other processes from the arylamine in the porous layers of the ink jet media of this invention, it may not be stabilized by an anion and subsequently it may more rapidly undergo a thermochromic reverse reaction to regenerate the arylamine. As used herein, the terms “aminium radical cation” and “aminium radical cations” refer both to salts of anions and aminium radical cations and to aminium radical cations without an anion present to form a salt compound.

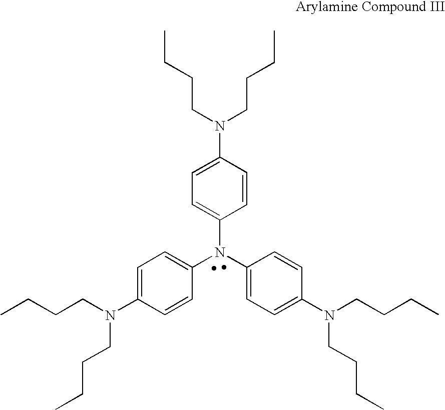

The arylamine compound III is the one-electron reduction product of the aminium radical cation I. Similarly, the arylamine compound IV is the one-electron reduction product of the aminium radical cation II. As can be seen in the chemical structure of arylamine compound III, the addition of one electron to the aminium radical cation I converts the radical cation moiety on the central nitrogen atom to a neutral amine moiety to thereby provide an arylamine as the one-electron reduction product of the aminium radical cation.

The chemical structure of the hexafluoroantimonate salt of tetrakis [4-(dibutylamino)phenyl]-1,4-benzenediamine radical cation, II, is shown below:

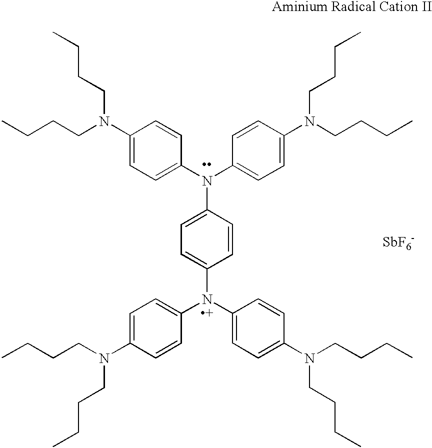

As can be seen in the chemical structure of arylamine compound IV below, the addition of one electron to the aminium radical cation II converts the radical cation moiety on one of the central nitrogens to a neutral amine moiety to thereby provide an arylamine as the one-electron reduction product of the aminium radical cation. If instead of a one-electron reduction, the aminium radical cation II undergoes a one-electron oxidation, then the neutral amine moiety on one of the central nitrogens is converted to a second radical cation moiety to thereby provide a radical cation that is a diradical dication. The one-electron oxidation product of the aminium radical cation II is commercially available as IR-165, a trademark for a dye available from GPT Glendale, Attleboro Falls, Mass. Unlike IR-99 and IR-126 which are yellow in color and must be used in low amounts to avoid discoloring the ink jet recording medium, IR-165 is a pale tan in color and can be added in larger amounts to the ink jet recording medium before causing readily visible discoloration. A two-electron reduction of IR-165 produces the arylamine compound IV as the reaction product.

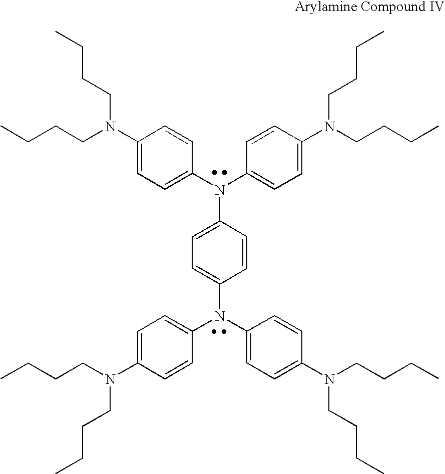

Thus, in one embodiment of the ink jet recording media of this invention, the arylamine is the one-electron reduction product of the aminium radical cation, such as, for example, the arylamine is compound III, and the aminium radical cation is compound I. In one embodiment, the arylamine is the two-electron reduction product of the aminium radical cation, such as, for example, the arylamine is compound IV, and the aminium radical cation is IR-165. In one embodiment, the aminium radical cation is a tetrakis (N,N-disubstituted aminophenyl)-1,4-benzenediamine radical cation, and preferably, the aminium radical cation is a tetrakis (N,N-dibutylaminophenyl)-1,4-benzenediamine radical cation. In one embodiment, the aminium radical cation is a tris (N,N-disubstituted aminophenyl) aminium radical cation, and preferably, the aminium radical cation is a tris (N,N-diarylaminophenyl) aminium radical cation. In one embodiment of the ink jet recording media of this invention, the N,N-disubstituted aminophenyls are selected from the group consisting of N,N-dialkylaminophenyls, N,N-diarylaminophenyls, and N-alkyl, N-arylaminophenyls. Suitable aryl moieties for the N,N-diarylaminophenyls and N-alkyl, N-arylaminophenyls include, but are not limited to, phenyl, naphthyl, 3-tolyl, and 4-tolyl. Suitable alkyl moieties for the N,N-dialkylaminophenyls and N-alkyl, N-arylaminophenyls include, but are not limited to, ethyl and n-butyl.

As a method of incorporating the aminium radical cation and the arylamine into the porous inorganic oxide layer, it is preferred to utilize a method of applying a solution containing the aminium radical cation and the arylamine dissolved in a suitable solvent, to the previously formed porous inorganic oxide layer by a coating, dipping, or spraying method to imbibe the stabilizing materials into the pores of the porous inorganic oxide xerogel layer. Alternatively, it is also possible to utilize a method where the stabilizing materials are mixed into the mixture containing the inorganic oxide for forming the porous ink-receptive layer.

Since the porous inorganic oxide layer, such as a pseudo boehmite xerogel layer, may convert some of the aminium radical cation to the corresponding arylamine by an electron transfer reduction process and, conversely, may convert some of the arylamine to the corresponding aminium radical cation by an electron transfer oxidation process, a mixture of an aminium radical cation and of an arylamine in the porous inorganic oxide layer may be prepared by adding either an aminium radical cation only or an arylamine only. Typically, within 24 to 48 hours, a specific ratio of the aminium radical cation and the corresponding arylamine will be obtained, and this ratio does not typically change significantly upon additional storage time. This stable ratio typically is in, but is not limited to, the molar range of 1:2 to 2:1 of aminium radical cation:arylamine. This combination of aminium radical cation and of its corresponding arylamine, in amounts that are extremely low such that discoloration due to the presence of the aminium radical cation is not evident, is particularly useful for stabilizing the ink jet recording medium and the imaged ink jet medium against color changes before and after ink jet printing. This includes stabilization against fading by light, by exposure to ozone and other active gases, and by other various types of oxidation.

The amount of the aminium radical cation is preferably from 0.01 to 0.5 weight percent based on the weight of the inorganic oxide in the porous layer, and more preferably, from 0.02 to 0.2 weight percent of the weight of the inorganic oxide in the porous layer. If the amount of the aminium radical cation is below 0.01 weight percent, the stabilization against fading of the color ink images is reduced. If the amount of the aminium radical cation is above 0.5 weight percent, the color of the aminium radical cation may start to be visible and objectionable. The amount of the arylamine is preferably from 0.01 to 1.0 weight percent based on the weight of the inorganic oxide in the porous layer, and more preferably, from 0.02 to 0.4 weight percent of the weight of the inorganic oxide in the porous layer. If the amount of the arylamine is below 0.01 percent, the stabilization against fading of the color ink images is reduced. If the amount of the arylamine is above 1.0 weight percent, the color of any oxidation products that may form from the arylamine may start to be visible and objectionable.

In one embodiment of the ink jet recording media of the present invention, the aminium radical cation is present in an amount of 0.01 to 5 weight percent of the amount of the inorganic oxide in the porous layer. In one embodiment, the arylamine is present in an amount of 0.01 to 5 weight percent of the amount of the inorganic oxide in the porous layer.

In this invention, the ink receptive layer is a porous layer that comprises an inorganic oxide and is very efficient in absorbing ink, providing fast drying, and fixing the colorant to the inorganic oxide layer. The porous inorganic oxide layer may be formed by applying a sol of an inorganic oxide to a substrate and drying the sol to form a sol gel layer of the porous inorganic oxide. Where the sol gel layer is formed directly from a liquid sol, the layer is referred to as a xerogel layer. As one alternative to an inorganic sol gel or xerogel layer, the porous layer comprises inorganic oxide particles, preferably inorganic oxide xerogel particles, and an organic polymer as a binder. The thickness of the porous layer is preferably from 1 to 50 microns, and more preferably from 3 to 25 microns.

The porous layer of this invention preferably comprises an inorganic oxide xerogel. Suitable inorganic oxide xerogels include, but are not limited to, silica xerogels, alumina xerogels, zirconium oxide xerogels, and combinations thereof. For example, it is known to have inorganic oxide xerogels comprised of silica and alumina in different weight ratios, as well as to have inorganic oxide xerogels comprised of alumina and zirconium oxide in different weight ratios. In a preferred embodiment, the inorganic oxide xerogel comprises a pseudo bochmite xerogel, as for example described in the afore-mentioned U.S. Pat. No. 5,104,730 to Misuda et al. The term “pseudo boehmite,” as used herein, pertains to hydrated aluminum oxides having the chemical formula, Al₂O₃.xH₂O, wherein x is in the range of 1.0 to 1.5. The ink jet recording media comprising a pseudo boehmite xerogel may be prepared by utilizing a bochmite sol made by hydrolyzing aluminum alkoxides, as, for example, described in U.S. Pat. No. 5,670,249 to Suzuki.

The coating application of the pseudo boehmite or other inorganic oxide porous layer on the substrate or on an intermediate layer previously applied to the substrate may be done by a wide variety of coating application methods, such as, for example, slot die coating, bar coating, gravure coating, roll coating, rod coating, and blade coating, following by drying to remove the liquids in the coating solution and to form the gel or xerogel from the sol coating mixture or to form the porous inorganic oxide layer from non-sol gel coating mixtures. For sol gel coatings, the organic polymer to provide binder properties is typically added to the sol, such as a boehmite sol, just prior to the coating application in order to reduce any tendency for gelation.

In one embodiment of the ink jet recording media of this invention, the inorganic oxide xerogel is selected from the group consisting of silica xerogels, alumina xerogels, zirconium oxide xerogels, and combinations thereof, and preferably, the inorganic oxide xerogel comprises a pseudo boehmite xerogel.

The porous inorganic oxide layer preferably is a xerogel and comprises an organic polymer as a binder to add mechanical strength and flexibility to the inorganic oxide xerogel. Suitable organic polymers include, but are not limited to, polyvinyl alcohol; modified polyvinyl alcohols; polyethylene oxide; modified polyethylene oxides; cellulosics such as hydroxymethyl cellulose,hydroxyethyl cellulose, and carboxyrnethyl cellulose; polyvinyl pyrrolidone; and modified polyvinyl pyrrolidones such as, for example, copolymers of vinyl pyrrolidone and acrylic acid.

In one embodiment of the ink jet recording media of this invention, the organic polymer for the binder of the porous layer is selected from the group consisting of polyvinyl alcohol, modified polyvinyl alcohols, polyethylene oxide, modified polyethylene oxides, cellulosics, polyvinyl pyrrolidone, and modified polyvinyl pyrrolidones. In a preferred embodiment, the organic polymer is selected from the group consisting of polyvinyl pyrrolidone and modified polyvinyl pyrrolidones.

A wide variety of substrates may be utilized in the present invention. The substrate may be any of the conventional supports used in printing, including both porous and non-porous types. There is no particular restriction on the thickness of the substrate, but the substrate is suitably of a thickness from 25 to 300 microns, and particularly from 50 to 175 microns. For example, suitable substrates include plastic films, such as polyethylene terephthalate, polyolefin, polyvinyl chloride, and polycarbonate films; papers including papers with a polyolefin layer on the surface of the paper; cloth; glass; metallic foils; and non-woven synthetic substrates. Depending on the intended purpose of the coated substrate, it is possible to use either a transparent or an opaque substrate, such as, for example, a white reflective paper or a white polyethylene terephthalate film. To improve the adhesion of the porous inorganic oxide layer to the substrate, a bonding coating or a corona discharge treatment may be applied to the substrate prior to applying the porous layer.

The metal ion of the inorganic oxide in the porous layer is positively charged or cationic. To enhance the stabilization of the ink jet images against fading by some form of oxidation or other chemical reaction in the ink jet recording media of the present invention, it has been found to be useful to add an anionic organic compound to the porous layer. Thus, in one embodiment, the porous layer comprises an anionic organic compound. Preferably, the anionic organic compound is added to the porous layer after the porous layer is formed but prior to the addition of the aminium radical cation and/or the addition of the arylamine. When the porous ink-receptive layer is a sol gel or xerogel layer, the negatively charged groups of the anionic organic compound may interact with the cationic inorganic oxide sol to interfere with the mixing and coating process and thus are not generally compatible with being added as part of the xerogel coating process. Also, since the aminium radical cations are positively charged, it is preferred to add the anionic organic compound first so that the subsequent addition of the aminium radical cation results in a complexing of the aminium radical cation to the anionic organic compound. Suitable anionic moieties for the anionic organic compound include, but are not limited to, sulfonate, carboxylate, and phosphate moieties. The anionic organic compound may have one or more anionic moieties or negatively charged groups, where the anionic moieties are the same or different in each occurrence.

The anionic organic compound may be applied to the porous inorganic oxide layer in an aqueous or organic solvent solution or blend thereof and then dried. In a preferred embodiment, the anionic organic compound is complexed to the inorganic oxide. This complexation is characterized by the insolubility of the anionic organic compound in the water or organic solvents or blend thereof from which the anionic organic compound was coated. For example, the extraction of the porous inorganic oxide layer containing the anionic organic compound for 10 minutes in the liquids used in the coating application of the anionic organic compound does not extract any of the complexed anionic organic compounds from the layer.

In a preferred embodiment of the ink jet recording media of this invention, the anionic organic compound complexed to the inorganic oxide comprises two or more anionic moieties on the anionic organic compound. Examples of such anionic organic compounds include, but are not limited to, poly(sodium 4-styrenesulfonate) and 9,10-anthraquinone-2,6-disulfonate sodium salt.

One of the benefits of two or more anionic moieties when the porous ink-receptive layer is a xerogel layer is apparently that the extremely small pore size of the inorganic oxide xerogel introduces sufficient steric constraints that a number of the anionic organic compound molecules only complex through one of their anionic moieties and their remaining anionic moieties are available for complexing to further cationic compounds, such as aminium radical cation compounds, that are added to the inorganic oxide xerogel layer. Thus, in a most preferred embodiment, the anionic organic compound comprising two or more anionic moieties is complexed to an inorganic oxide xerogel and to the aminium radical cation. This complexation between the inorganic oxide xerogel and the aminium radical cation is characterized by the insolubility of the aminium radical cation in the water or organic solvents or blend thereof from which the aminium radical cation compound was coated. For example, the extraction of the inorganic oxide xerogel layer containing the complexed aminium radical cation for 10 minutes in the liquids used in the coating application of the aminium radical cation compound does not extract any of the complexed aminium radical cation from the layer. The complexation of the aminium radical cation to an anionic moiety of the anionic organic compound, which in turn is complexed to the inorganic oxide xerogel, is particularly effective in stabilizing the aminium radical cation so that the effective stabilizing action of the aminium radical cation is maintained without undesirable side reactions during the storage of the ink jet recording media and of the imaged ink jet media. For example, when the aminium radical cation is of the IR-165 type of diradical dication, the complexation to the anionic organic compound may be very useful in stabilizing the nearly colorless, light tan IR-165 type aminium radical cation against reaction in the inorganic oxide xerogel to form a more colored compound, such as to reduce to the yellow IR-126 type aminium radical cation.

Ink jet recording media with porous inorganic oxide xerogel layers are particularly suited to dye-based ink jet inks where the colorant is soluble in the liquid of the ink jet ink. The rapid absorptivity of the porous xerogel provides excellent drying properties, and the cationic nature of the inorganic oxide xerogel, and optionally of the organic polymer, fixes or complexes the anionic moieties of the colorant to achieve excellent image sharpness and density. In contrast, pigment-based ink jet inks typically contain pigments that are too large to fit into the pores of the inorganic oxide xerogel layer. For example, pigments such as carbon black or cyan pigment particles typically have diameters in the range of 50 to 150 nm while the inorganic oxide xerogels, such as those comprising pseudo boehmite xerogels, typically have pore diameters in the range of 3 to 10 nm. As a consequence of these size differences, the pigments are retained on the surface of the imaged ink jet media where the pigments may be mechanically abraded or scraped off, thereby deteriorating the quality of the ink jet image. Thus, when the black and colored ink jet inks used to make the imaged ink jet medium include one or more pigmented inks, it is useful to include a porous surface layer where the pores are large enough to accommodate the pigments of the pigmented inks and the porosity allows the liquids and any soluble colorants in the liquids to be absorbed into the porous inorganic oxide xerogel layer.

Accordingly, one aspect of the ink jet recording media of the present invention pertains to an ink jet recording medium comprising a substrate and a porous layer, wherein the porous layer comprises an inorganic oxide xerogel, an organic polymer, an aminium radical cation, and an arylamine, wherein the medium further comprises a porous surface layer having polymer particles which have not coalesced to form a uniform, continuous film. By not forming a uniform, continuous film, the polymer particles provide a porous layer where the pores are much larger than the pore sizes typical of inorganic oxide xerogel layers and are of a size that allows any pigments in the ink jet inks to settle into the pores of the porous surface layer. This enhances the stability of the pigmented ink images against mechanical smearing or removal without interfering with the rapid drying and image quality of the dye ink images.

The porous surface coating is comprised of non-film forming polymer particles, wherein the particles have not coalesced to form a uniform, continuous film. Because the polymer particles do not coalesce to form a continuous film, there exists spacing between the non-film forming polymer particles. These spacings or pores may exist throughout the porous surface layer and are large enough to accommodate the pigments of the pigmented ink jet inks inside the pores. Suitable non-coalescing polymer particles for the porous surface layers of this invention include, but are not limited to, non-film forming styrenated acrylics available from S.C. Johnson, Racine, Wis., under the trademark of JONCRYL. These and other suitable non-coalescing polymer particles are described in U.S. Pat. No. 5,308,680 to Desjarlais et al. for use in acceptor sheets for mass transfer imaging, such as wax thermal transfer imaging. The thickness of the porous surface layer may vary from 0.05 to 5 microns, and preferably is in the range of 0.2 to 0.8 microns. In a preferred embodiment, the porous surface layer comprises an inorganic oxide. This inorganic oxide is useful in enhancing the receptivity to the liquid phase of the ink jet inks without diminishing the receptivity of the porous surface layer to the pigments of the ink jet inks. The amount of the inorganic oxide in the porous surface layer may vary over a wide range and preferably is from 10% to 70% of the weight of the porous surface layer. In another preferred embodiment, the porous surface layer comprises an organic polymer selected from the group consisting of polyvinyl alcohol, modified polyvinyl alcohols, polyethylene oxide, modified polyethylene oxides, cellulosics, polyvinyl pyrrolidone, and modified polyvinyl pyrrolidones. This polymer is useful in enhancing the receptivity of the porous surface layer to the liquid phase of the ink jet inks, especially where the liquid phase has a high water content and may not wet well on the non-coalescing polymer particles. The amount of the polymer in the porous surface layer is low enough to maintain the non-continuous, porous nature of the surface layer and is typically in the range of 5% to 50% by weight of the porous surface layer. In one embodiment, the porous surface layer comprises an aminium radical cation and an arylamine. These stabilizing additives are useful to stabilize any dyes that are retained in the thin porous surface layer and also may be present from their coating application to the ink jet recording media after the formation of the porous surface layer.

Another aspect of this invention pertains to an imaged ink jet recording media comprising a substrate, a porous layer, and a colorant applied in an imagewise pattern by an ink jet printer, wherein the porous layer comprises an inorganic oxide, an organic polymer, an aninum radical cation, and an arylamine. The porous layer may be any of the variations described for the porous layer containing an inorganic oxide of the ink jet recording media of the present invention. This includes the variations having an anionic organic compound complexed to the inorganic oxide and those variations having a porous surface layer comprising polymer particles which have not coalesced to form a uniform, continuous film.

Still another aspect of this invention pertains to an imaged ink jet recording media comprising a substrate, a porous surface layer, a porous xerogel layer interposed between the substrate and the porous surface layer, and a colorant applied in an imagewise pattern by an ink jet printer, wherein the porous xerogel layer comprises an inorganic oxide xerogel, an organic polymer, an aminium radical cation, and an arylamine, and wherein the surface layer comprises polymer particles coalesced by the application of heat and/or pressure subsequent to the application of the colorant by the ink jet printer. This subsequent coalescing of the polymer particles is useful in further enhancing the stability of the imaged ink jet recording media by encapsulating any pigment particles in the coalesced or continuous surface layer and by providing a sealed layer at the top surface to prevent or lessen the exposure of the colorants to gases and moisture. In one embodiment, the porous surface layer comprises an inorganic oxide xerogel.

One aspect of the methods of preparing an imaged ink jet recording medium of the present invention comprises the steps of (i) providing an ink jet recording medium comprising a substrate and a porous layer, as described herein, wherein the porous layer comprises an inorganic oxide, an organic polymer, an aminium radical cation, and an arylamine; and (ii) using an ink jet printer to apply an imagewise pattern of an ink jet ink comprising a colorant to the porous layer.

Another aspect of the methods of preparing an imaged ink jet medium of this invention comprises the steps of (i) providing an ink jet recording medium comprising a substrate and a porous layer, wherein the porous layer comprises an inorganic oxide and an organic polymer; (ii) using an ink jet printer to apply an imagewise pattern of an ink jet ink comprising a colorant and an aminium radical cation to the porous layer; and (iii) forming a mixture of the aminium radical cation and an arylamine in the imagewise pattern, wherein the arylamine is a reduction product of the aminium radical cation. In one embodiment, the aminium radical cation comprises an anionic moiety. Suitable anionic moieties include, but are not limited to, sulfonate, carboxylate, and phosphate moieties. The anionic moiety on the aminium radical cation may provide increased solubility in water so the aminium radical cation may be dissolved at the desired concentration, such as 0.02% by weight, in an water-based ink jet ink. Such aqueous ink jet inks may be 100% water or may contain a blend of water and organic solvents, such as glycols and 2-pyrrolidone. In one embodiment, the arylamine undergoes a photochromic change to the aminium radical cation upon exposure to ultraviolet light and is subsequently formed in a thermochromic reverse reaction from the aminium radical cation back to the arylamine. These photochromic and thermochromic reactions are one process that forms the mixture of the aminium radical cation and the arylamine in the imagewise pattern. In one embodiment, the substrate is a white reflective substrate and the photochromic change is greater than a 5% reflectance change at 1065 nm, such as, for example, a change in % reflectance at 1065 nm from 96% to 89% or a 7% reflectance change.

Still another aspect of the methods of preparing an imaged ink jet medium of this invention comprises the steps of (i) providing an ink jet recording medium comprising a substrate and a porous layer, wherein the porous layer comprises an inorganic oxide and an organic polymer; (ii) using an ink jet printer to apply an imagewise pattern of an ink jet ink comprising a colorant and an arylamine to the porous layer; and (iii) forming a mixture of the arylamine and an aminium radical cation in the imagewise pattern, wherein the arylamine is a reduction product of the aminium radical cation. In one embodiment, the arylamine comprises an anionic moiety. Suitable anionic moieties include, but are not limited to, sulfonate, carboxylate, and phosphate moieties. The anionic moiety on the arylamine may provide increased solubility in water so the arylamine may be dissolved at the desired concentration, such as 0.02% by weight, in an water-based ink jet ink. Such aqueous ink jet inks may be 100% water or may contain a blend of water and organic solvents, such as glycols and 2-pyrrolidone. In one embodiment, the arylamine undergoes a photochromic change to the aminium radical cation upon exposure to ultraviolet light and is subsequently formed in a thermochromic reverse reaction from the aminium radical cation back to the arylamine. These photochromic and thermochromic reactions are one process that forms the mixture of the aminium radical cation and the arylamine in the imagewise pattern. In one embodiment, the substrate is a white reflective substrate and the photochromic change is greater than a 5% reflectance change at 1065 nm, such as, for example, a change in % reflectance at 1065 nm from 96% to 89% or a 7% reflectance change.

### EXAMPLES

Several embodiments of the present invention are described in the following examples, which are offered by way of illustration and not by way of limitation.

### Example 1

A porous layer of pseudo boehmite with polyvinyl alcohol binder present was prepared according to the following procedure. A coating mixture with a solids content of about 15.4% comprising 14 weight percent (solid content) of boehmite sol and 1.4 weight percent (solid content) of a polyvinyl alcohol polymer in water was prepared. This coating solution was coated on a polyester (polyethylene terephthalate) substrate of 125 microns in thickness using a gap coater so that the coating amount after drying at 140° C. for 5 minutes was 25 g/m², to form a porous pseudo boehmite layer of about 25 microns in thickness. The porous layer with a porosity of about 60% was impregnated with a 0.05 weight percent solution of equal amounts of IR-99, aminium radical cation compound I, and its corresponding arylamine compound III in 2-butanone using a #3 wire wound rod followed by drying at room temperature. The combined weight of the aminium radical cation I and the arylamine compound III in the pseudo boehmite layer was 0.025 g/m². This equates to 0.1 weight percent of the weight of the porous pseudo boehmite layer.

### Example 2

The porous pseudo boehmite layer was prepared as described in Example 1. The porous layer was impregnated with a 0.05 weight percent solution of equal amounts of IR-126, aminium radical cation compound II, and its corresponding arylamine compound IV in 2-butanone using a #3 wire wound rod followed by drying at room temperature. The combined weight of the aminium radical cation II and the arylamine compound IV in the pseudo boehmite layer was 0.025 g/m². This equates to 0.1 weight percent of the weight of the porous pseudo boehmite layer.

### Example 3

The porous pseudo boehmite layer was prepared as described in Example 1. The porous layer was impregnated with a I weight percent solution of 9,10-anthraquinone-2,6-sulfonate disodium salt, available from Aldrich Chemical Company, Inc., Milwaukee, Wis., in water using a #3 wire wound rod followed by drying at room temperature. The porous layer was impregnated with a 0.1 weight percent solution of IR-165 in 2-butanone using a #3 wire wound rod followed by drying at room temperature. The layer was then extracted for 5 minutes in a solution of acetone. After the extraction, the weight of IR-165 in the pseudo boehmite layer was 0.03 g/m². This equates to about 0.1 weight percent of the weight of the porous pseudo boehmite layer.

### Example 4

The porous pseudo boehmite layer containing the aminium radical cation II and the arylamine compound IV of Example 2 was overcoated with a porous surface layer by coating a solution of the mix of Example 1 in U.S. Pat. No. 5,308,680 to Desjarlais et al. using a #3 wire wound rod followed by drying at room temperature to form a 0.5 micron thick surface layer. This surface layer was microrough due to the non-film forming nature of the Joncryl 87, which is a trademark for dispersed styrenated acrylic polymer particles available from S. C. Johnson, Racine, Wis. Under these coating and drying conditions, the polymer particles did not coalesce to form a uniform, continuous film. Instead, because the polymer particles are larger than the pores of the xerogel layer, the surface layer did not penetrate into the porous inorganic oxide layer and was microrough and porous such that dye-based inks readily passed through the surface layer and pigment-based inks deposited the pigment in the pores of the surface layer while the liquid in the pigment-based inks was absorbed into the porous inorganic oxide xerogel layer.

### Example 5

The same procedure was followed as in Example 4 except that the surface layer was formed by coating a solution of the mix of Example 4 in the above-mentioned U.S. Pat. No. 5,308,680 to Desjarlais et al. The surface layer was 0.5 micron thick and was microrough and porous.

### Comparative Example 1

A porous pseudo boehmite layer was prepared as in Example 1 except that no impregnation with a stabilizer material was done.

For each of the ink jet imaging media of Examples 1 to 5 and the Comparative Example 1, a color pattern was printed using a DeskJet 932C ink jet printer, a trademark for an ink jet printer available from Hewlett Packard Corporation, Palo Alto, Calif. The yellow, cyan, and magenta colors printed were from dye-based inks, and the black color printed was from a pigment-based ink. The absorption and drying rate of the ink, the non-imaged background appearance, and the image resolution and clarity was excellent for all of these examples. Each of these imaged examples was irradiated with light from a 75 W Oriel xenon-mercury lamp, a trademark for a lamp available from Thermo Electron, Franklin, Mass. After 80 hours of irradiation, the changes in the image were visually evaluated. There was a significant fading of the color in Comparative Example 1, especially in the yellow and magenta colors, whereas the change in color was insignificant in Examples 1 to 5. The samples of Example 3 where the IR-165 aminium radical cation was complexed showed no change upon storage for 1 month. In contrast, samples made as described in Example 3 but without the addition of the anionic organic compound and also without the solvent extraction step showed significant conversion to the more highly colored IR-126 type aminium radical cation upon storage for 2 days. After the 80 hours of irradiation described above, the samples of Example 3 showed low levels of IR-126 and arylamine compound IV type compounds but were stable against color fading, as described above.

After color ink jet printing of Examples 4 and 5, they were heated at 150° C. for 5 minutes with pressure on the surface to coalesce the polymer particles of the surface coating. This sealing of the surface added to the stability of the ink jet image by reducing the tendency for the black pigment to be abraded or wiped from the ink jet medium because the pigment is too large to penetrate into the porous inorganic oxide layer and by providing a sealed surface against oxidation by oxygen, ozone, and other materials to further reduce the tendency for fading of the yellow, magenta, and cyan dye images that are in the porous inorganic oxide layer.

### Example 6

A 0.2% by weight solution in toluene of 4,4′,4″-tris(N-3-methylphenyl-N-phenylamino)-triphenylamine, commonly referred to as MTDATA and available from H. W. Sands Corporation in Jupiter, Fla., under the trade name of OPA3939, was coated with a #3 wire wound rod onto Epson Photo Quality Glossy Paper, an ink jet paper available from Seiko Epson Corporation, Tokyo, Japan, under the trademark of EPSON. After drying in the air for 1 hour, a magenta color pattern was printed using a Hewlett Packard DeskJet 932C ink jet printer. The imaged ink jet media with the arylamine stabilizer present was irradiated with light from the 75 W Oriel xenon-mercury lamp at a distance of about 12 inches with the light focused on a circle of about 2 inches in diameter on the magenta-imaged areas. The fading of the magenta ink image was monitored by measuring the % reflectance of the magenta ink image at 569 nm on a Cary 500 spectrophotometer with reflectance accessories, available from Varian Instruments, Walnut Creek, Calif., under the trade name of CARY. The photochromic formation of the one-electron oxidation product of MTDATA to form the corresponding aminium radical cation during the light exposure was monitored by measuring the % reflectance at 1065 nm on the Cary 500 spectrophotometer. The reverse reation of the aminium radical cation in the dark or by the application of heat was also measured by monitoring the % reflectance at 1065 nm.

From monitoring the changes in % reflectance at 569 nm for the magenta image area, Example 6 showed 60% more stability to fading over a light exposure period of 11 hours compared to a control sample of the magenta ink image from the DeskJet 932C ink jet printer on the Epson Photo Quality Glossy Paper with no MTDATA present. During the photolysis, the MTDATA rapidly formed the aminium radical cation from a photon-induced one-electron oxidation process upon the absorption of ultraviolet light. The aminium radical cation had a visible absorption peak at about 445 nm and a broad IR absorption band from 700 nm to around 1500 nm. The visible and IR photochromic product had a thermochromic reverse reaction to form at least some of the original MTDATA. Thus, irradiation of the colorless, white Epson ink jet paper with the MTDATA arylamine present of this example caused the formation of a very light yellow color with a decrease in % reflectance at 1065 nm from about 96% to about 89%, or a change in % reflectance of 7% due to the stong IR absorption of the aminium radical cation formed. In the dark at a room temperature of about 22° C., the aminium radical cation underwent a reverse thermochromic reaction to form the MTDATA arylamine. After 30 minutes in the dark, the reverse reaction was about 50% complete. This reverse reaction was heat-activated with the rate of the reverse reaction increasing by a factor of about 2 with every 10° C. increase in temperature.

Even after the 11 hours of photolysis with the 75 W xenon-mercury lamp, Example 6 with MTDATA arylamine present still showed the reversible visible and IR photochromic properties in the magenta-imaged areas. In contrast, the control Epson Photo Quality Glossy Paper samples without MTDATA arylamine present showed no visible and IR photochromic properties during the 11 hours of photolysis with the 75 W xenon-mercury lamp.

When Example 6 with MTDATA arylamine present was exposed to the high-intensity xenon-mercury lamp, a mixture of the aminium radical cation and the MTDATA arylamine was present with the aminium radical cation being in a much higher concentration than the arylamine. In the dark or at lower light intensities such as when the ink jet image was exposed to ambient room light and/or sunlight coming through windows, a mixture of the aminium radical cation and the MTDATA arylamine was also present with the relative concentrations or amounts being dependent on the light intensity or the time in the dark, but having more MTDATA arylamine present than when under the very high light fluence of the 75 W xenon-mercury lamp. After long periods in the dark after being exposed to light, Example 6 with MTDATA arylamine present was also a mixture of the aminium radical cation and the MTDATA arylamine, but the arylamine was over 90% of the mixture.

While the invention has been described in detail and with reference to specific and general embodiments thereof, it will be apparent to one skilled in the art that various changes and modifications can be made therein without departing from the spirit and scope thereof.

1. An ink jet recording medium comprising a substrate and a porous layer, wherein said porous layer comprises an inorganic oxide, an organic polymer, an aminium radical cation, and an arylamine.

2. The medium of claim 1, wherein said arylamine is the one-electron reduction product of said aminium radical cation.

3. The medium of claim 1, wherein said arylamine is the two-electron reduction product of said aminium radical cation.

4. The medium of claim 1, wherein said aminium radical cation is a tetrakis (N,N-disubstituted aminophenyl)-1,4-benzenediamine radical cation.

5. The medium of claim 4, wherein said N,N-disubstituted aminophenyl is selected from the group consisting of N,N-dialkylaminophenyls, N,N-diarylaminophenyls, and N-alkyl, N-aryl aminophenyls.

6. The medium of claim 1, wherein said aminium radical cation is a tris (N,N-di-substituted aminophenyl) aminium radical cation.

7. The medium of claim 6, wherein said N,N-disubstituted aminophenyl is selected from the group consisting of N,N-dialkylaminophenyls, N,N-diarylaminophenyls, and N-alkyl, N-aryl aminophenyls.

8. The medium of claim 1, wherein said aminium radical cation is present in an amount of 0.01 to 5 weight percent of the amount of said inorganic oxide in said porous layer.

9. The medium of claim 1, wherein said arylamine is present in an amount of 0.01 to 5 weight percent of the amount of said inorganic oxide in said porous layer.

10. The medium of claim 1, wherein said inorganic oxide is a xerogel selected from the group consisting of silica xerogels, alumina xerogels, zirconium oxide xerogels, and combinations thereof.

11. The medium of claim 10, wherein said inorganic oxide xerogel comprises a pseudo boehmite xerogel.

12. The medium of claim 1, wherein said organic polymer is selected from the group consisting of polyvinyl alcohol, modified polyvinyl alcohols, polyethylene oxide, modified polyethylene oxides, cellulosics, polyvinyl pyrrolidone, and modified polyvinyl pyrrolidones.

13. The medium of claim 1, wherein said porous layer comprises an anionic organic compound.

14. The medium of claim 13, wherein said anionic organic compound comprises an anionic moiety selected from the group consisting of sulfonate, carboxylate, and phosphate moieties.

15. The medium of claim 13, wherein said anionic organic compound is complexed to said inorganic oxide.

16. The medium of claim 15, wherein said anionic organic compound complexed to said inorganic oxide comprises two or more anionic moieties on said anionic organic compound.

17. The medium of claim 16, wherein said anionic organic compound comprising two or more anionic moieties is complexed to said inorganic oxide and to said aminium radical cation.

18. The medium of claim 1, wherein said aminium radical cation comprises an anionic moiety selected from the group consisting of sulfonate, carboxylate, and phosphate moieties.

19. The medium of claim 1, wherein said arylamine comprises an anionic moiety selected from the group consisting of sulfonate, carboxylate, and phosphate moieties.

20. The medium of claim 1, wherein said medium comprises a porous surface layer, wherein said porous surface layer comprises polymer particles which have not coalesced to form a uniform, continuous film.

21. The medium of claim 20, wherein said porous surface layer comprises an inorganic oxide.

22. The medium of claim 20, wherein said porous surface layer comprises an organic polymer selected from the group consisting of polyvinyl alcohol, modified polyvinyl alcohols, polyethylene oxide, modified polyethylene oxides, cellulosics, polyvinyl pyrrolidone, and modified polyvinyl pyrrolidones.

23. The medium of claim 20, wherein said porous surface layer comprises an aminium radical cation and an arylamine.

24. An imaged ink jet recording medium comprising a substrate, a porous layer, and a colorant applied in an imagewise pattern by an ink jet printer, wherein said porous layer comprises an inorganic oxide, an organic polymer, an aminium radical cation, and an arylamine.

25. The imaged medium of claim 24, wherein said arylamine is the one-electron reduction product of said aminium radical cation.

26. The imaged medium of claim 24, wherein said arylamine is the two-electron reduction product of said aminium radical cation.

27. The imaged medium of claim 24, wherein said aminium radical cation is a tetrakis (N,N-disubstituted aminophenyl)-1,4-benzenediamine radical cation.

28. The imaged medium of claim 24, wherein said aminium radical cation is a tris (N,N-disubstituted aminophenyl) aminium radical cation.

29. The imaged medium of claim 24, wherein said porous layer comprises an anionic organic compound.

30. The imaged medium of claim 29, wherein said anionic organic compound is complexed to said inorganic oxide.

31. The imaged medium of claim 30, wherein said anionic organic compound complexed to said inorganic oxide comprises two or more anionic moieties on said anionic organic compound.

32. The imaged medium of claim 31, wherein said anionic organic compound comprising two or more anionic moieties is complexed to said inorganic oxide and to said aminium radical cation.

33. The imaged medium of claim 24, wherein said aminium radical cation comprises an anionic moiety selected from the group consisting of sulfonate, carboxylate, and phosphate moieties.

34. The imaged medium of claim 24, wherein said arylamine comprises an anionic moiety selected from the group consisting of sulfonate, carboxylate, and phosphate moieties.

35. The imaged medium of claim 24, wherein said medium comprises a porous surface layer, wherein said porous surface layer comprises polymer particles which have not coalesced to form a uniform, continuous film.

36. The imaged medium of claim 35, wherein said porous surface layer comprises an inorganic oxide.

37. The imaged medium of claim 35, wherein said porous surface layer comprises a binder selected from the group consisting of polyvinyl alcohol, modified polyvinyl alcohols, polyethylene oxide, modified polyethylene oxides, cellulosics, polyvinyl pyrrolidone, and modified polyvinyl pyrrolidones.

38. The imaged medium of claim 35, wherein said porous surface layer comprises an aminium radical cation and an arylamine.

39. An imaged ink jet recording medium comprising a substrate, a porous surface layer, a porous xerogel layer interposed between said substrate and said porous surface layer, and a colorant applied in an imagewise pattern by an ink jet printer, wherein said porous xerogel layer comprises an inorganic oxide xerogel, an organic polymer, an aminium radical cation, and an arylamine, and wherein said porous surface layer comprises polymer particles coalesced by the application of heat and pressure subsequent to the application of said colorant by said ink jet printer.

40. The imaged medium of claim 39, wherein said porous surface layer comprises an inorganic oxide.

41. A method of preparing an imaged ink jet recording medium, which method comprises the steps of:
(i) providing an ink jet recording medium comprising a substrate and a porous layer, wherein said porous layer comprises an inorganic oxide, an organic polymer, an aminium radical cation, and an arylamine; and
(ii) using an ink jet printer to apply an imagewise pattern of an ink jet ink comprising a colorant to said porous layer.

42. A method of preparing an imaged ink jet recording medium, which method comprises the steps of:
(i) providing an ink jet recording medium comprising a substrate and a porous layer, wherein said porous layer comprises an inorganic oxide and an organic polymer;
(ii) using an ink jet printer to apply an imagewise pattern of an ink jet ink comprising a colorant and an aminium radical cation to said porous layer; and
(iii) forming a mixture of said aminium radical cation and an arylamine in said imagewise pattern, wherein said arylamine is a reduction product of said aminium radical cation.

43. The method of claim 42, wherein said aminium radical cation comprises an anionic moiety selected from the group consisting of sulfonate, carboxylate, and phosphate moieties.

44. The method of claim 42, wherein said arylamine undergoes a photochromic change to said aminium radical cation upon exposure to ultraviolet light and is subsequently formed in a thermochromic reverse reaction from said aminium radical cation to said arylamine.

45. The method of claim 44, wherein said substrate is a white reflective substrate and said photochromic change is greater than a 5% reflectance change at 1065 nm.

46. A method of preparing an imaged ink jet recording medium, which method comprises the steps of:
(i) providing an ink jet recording medium comprising a substrate and a porous layer, wherein said porous layer comprises an inorganic oxide and an organic polymer;
(ii) using an ink jet printer to apply an imagewise pattern of an ink jet ink comprising a colorant and an arylamine to said porous layer; and
(iii) forming a mixture of said arylamine and an aminium radical cation in said imagewise pattern, wherein said arylamine is a reduction product of said aminium radical cation.

47. The method of claim 46, wherein said arylamine comprises an anionic moiety selected from the group consisting of sulfonate, carboxylate, and phosphate moieties.

48. The method of claim 46, wherein said arylamine undergoes a photochromic change to said aminium radical cation upon exposure to ultraviolet light and is subsequently formed in a thermochromic reverse reaction from said aminium radical cation to said arylamine.

49. The method of claim 48, wherein said substrate is a white reflective substrate and said photochromic change is greater than a 5% reflectance change at 1065 nm.
